(19) United States
(12) Patent Application Publication
(10) Pub. No.: US 2007/0156737 A1
(43) Pub. Date: Jul. 5, 2007

(54) APPLICATION INTEGRATION SYSTEMS AND METHODS

(75) Inventor: Nick Barnes, Orlando, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/469,792

(22) Filed: Sep. 1, 2006

Related U.S. Application Data
(60) Provisional application No. 60/751,355, filed on Dec. 15, 2005.

(51) Int. Cl. G06F 7/00

(52) U.S. Cl. 707/101

(57) ABSTRACT

Systems and methods are disclosed for integrating applications that use different message formats. In one embodiment, the method comprises receiving, at an application integrator, a message in a first format from a first application. A message type for the message is determined and metadata associated with the message type is retrieved. The metadata includes at least one mapping associating a data element in the first format to a data element in a second format. The method further comprises using the metadata to adapt the message in the first format to a message in the second format and transmitting the message in the second format to a second application. The method further comprises optimization algorithms and meta-data storage designed to perform transformations at a very high speed with minimal impact to overall message performance.

### CROSS REFERENCES TO RELATED APPLICATIONS

This application is a continuation in part application and claims the benefit of copending U.S. Application No. 60/751,355, filed Dec. 15, 2005, the complete disclosure of which is herein incorporated by reference.

### BACKGROUND OF THE INVENTION

In today's automated business environment, system environments can be highly complex. A system environment may require communication among components with a wide degree of variation in platforms, programming languages, and operating systems. For instances, a front-end application that interfaces with users may operate on a Microsoft® or UNIX server. The front-end application may access services provided by another application (sometimes referred to as a back-end application) that may run on a mainframe computer.

Integrating applications that run on different platforms is a challenging process. A system architect may want to use a common messaging scheme, such as Extended Markup Language (XML), to transmit messages between applications. With this type of architecture, both applications must accept the same type of message format. Alternatively, messages must be converted between different formats. For instances, an XML message sent from a first application may be converted to Common Business Oriented Language (COBOL) message used by a second application.

Commercial products, such as the XML Toolkit provided by IBM®, are available to convert XML messages to COBOL. However, the techniques used by the currently available message converters may be too slow for some environments. As one example, an account management system that handles inquiries and processing for credit and financial accounts may typically need to process over 50 transactions per second. In extreme examples this number may be much higher. In these types of environments, the system architect cannot take advantage of common messaging between applications as the conversion process takes too long. Thus, the system architect may be forced to use other less desirable architectures, which may tightly bind an application to implementation specific details of another application.

### BRIEF SUMMARY OF THE INVENTION

Systems, methods, and machine-readable mediums are disclosed for integrating applications that use different message formats. In some embodiments, the method comprises receiving, at an application integrator, a message in a first format (e.g., XML or COBOL) from a first application. By way of example, the message may comprise a financial account information request or a financial account authorization message. The application integrator determines a message type for the message and retrieves metadata associated with the message type. The metadata may include at least one mapping associating a data element in the first format to a data element in a second format (e.g., COBOL or XML). The metadata may then be used to adapt the message in the first format to a second message in the second format. The second message is then transmitted to a second application.

In some aspects, the message may include an input data element. In these aspects, using the metadata to adapt the message may comprise determining a corresponding data element in the second format for the input data element. In further aspects, the method may further comprise retrieving second metadata. The second metadata includes data structure information (e.g., data type, field length, data position, and/or other structural information) for the corresponding data element. In these further aspects, the second metadata is also used to adapt the message to the second format. For instances, the data structure information may be used to convert a data value associated with the input data element from the first format to the second format.

The method may, in some embodiments, further comprise generating the second metadata for the corresponding data element or other data elements in the second format which correspond to input or output data elements in the first format. Merely by way of example, generating the second metadata may comprise parsing program code, such as a COBOL copybook, to obtain the data structure information.

In yet other aspects, the method may further comprise receiving a response message in the second format from the second application. The metadata may be retrieved and used to adapt the response message to a second response message in the first format. In one exemplary embodiment, the response message may include an output data element. In this exemplary embodiment, adapting the message may comprise retrieving second metadata which includes data structure information for the output data element and using the second metadata to obtain a data value associated with the output data element from the response message. After the response message is adapted to the second response message, it may be transmitted to the first application.

In other embodiments, the method may comprise parsing program code (e.g., a COBOL copybook) to obtain metadata for data elements included in the program code. The metadata includes data structure information for the data elements. Merely by way of example, the data structure information may comprise a data type, a field length, a data position, and/or other structural information about a data element. The metadata may then be stored and used to convert a message from a first format associated with the program code to a second format.

In still other embodiments, an application integration system is disclosed which comprises at least one message interface, a data store, logic, and a second communications interface. The first communications interface is configured to receive a message in a first format from a first application. The data store includes a plurality of message definitions for message types in the first format. Each message definition may include one or more mappings associating a data element in the first format to a data element in the second format. The logic is communicatively coupled with the first communications interface and the metadata and is configured to determine a message type associated with the message. The logic is also configured to retrieve the message definition associated with the determined message type and to adapt the message to a second message in the second format based at least in part on the retrieved message definition. The at least one message interface is also configured to transmit the second message to a second application.

The application integration system may, in further embodiments, also comprise second metadata. The second metadata includes data structure information for one or more data elements included in a function associated with the second application. In these embodiments, the logic may be configured to use the second metadata to adapt the message. In some aspects, the logic may be further configured to generate the second metadata. For example, the logic may be configured to generate the second metadata by parsing the source code associated with the function.

A further understanding of the nature and advantages of the present invention may be realized by reference to the remaining portions of the specification and the drawings.

### BRIEF DESCRIPTION OF THE DRAWINGS

Illustrative embodiments in accordance with the invention are illustrated in the drawings in which:

FIG. 1 illustrates an exemplary embodiment of a system that may use an application integrator to integrate applications using different message formats;

FIG. 2 is a block diagram illustrating an exemplary embodiment of an application integrator;

FIG. 3 is an exemplary embodiment of a metadata repository that may be included as a component of an application integrator;

FIG. 4 is a block diagram of an exemplary computer system upon which an application integrator may be implemented;

FIG. 5 is a flow diagram illustrating an exemplary method that may be used to adapt a message from a first format to a second format;

FIG. 6 is a flow diagram of an exemplary method that may be used to generate metadata used by an application integrator to adapt messages to a different format;

FIG. 7 is a flow diagram illustrating an exemplary method that may be used to adapt an XML message to a COBOL message; and

FIG. 8 is a flow diagram illustrating an exemplary method that may be used to adapt a COBOL message to an XML message.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

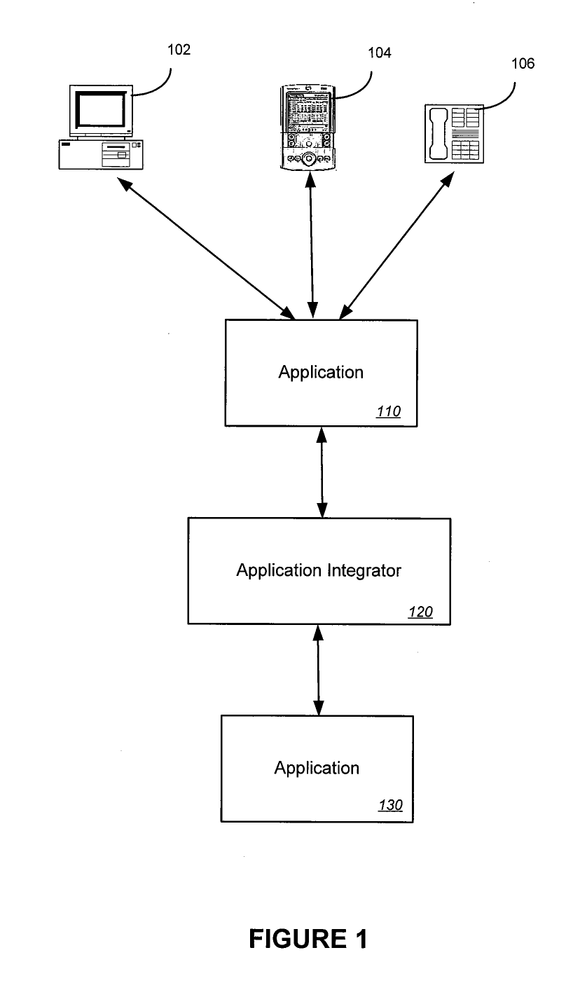

FIG. 1 illustrates an exemplary embodiment of a system that may use an application integrator 120 to integrate applications 110, 130 using different message formats. Applications 110, 130 may be any type of application that communicates with another application 110, 130 that uses a different message format. In some embodiments, application 110 may be a front-end application that may interact with users. A user may access application 110 using a client computer 102, a handheld device 104 (e.g., mobile device, such as a Blackberry® or similar type of device), a telephone 106, and/or any other type of device. In other embodiments, application 110 may not communicate with user devices 102, 104, 106.

Application integrator 120 may function as message-oriented middleware that provides the infrastructure for message-based communication dialogs between applications 110, 130. Hence, application integrator 120 is communicatively coupled with applications 110, 120. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that application integrator 120 may reside on the same or different physical device as application 110 and/or application 130.

As will be described in further detail below, application integrator 120 may adapt messages received in a first format from application 110 to a second format used by application 130. The application integrator 120 may then transmit the adapted message to application 130. Application integrator 120 may also be used to adapt messages received from application 130 to the format used by application 110. In further embodiments, additional applications (not illustrated) may also use application integrator 120 to adapt messages for transmittal to application 110 and/or application 130. The additional application(s) may use one of the formats used by application 110 or application 130, or may use a different message format. Thus, it should be appreciated that application integrator 120 may adapt messages to multiple types of formats.

In an exemplary system environment, application 110 may reside on a UNIX or Microsoft® server. User devices 102, 104, 106 may interact with application 110 via a public area network, such as the Internet. To fulfill user requests, application 110 may use one or more services provided by application 130. In some embodiments, application 130 may reside on a mainframe computer. Optionally, in these aspects, application integrator 120 may also reside on the mainframe computer, which may allow for faster transaction processing time. Each application 110, 130 may use a different message format for its messages. Merely by way of example, application 110 may use XML as its message format and application 130 may use COBOL for its messages. Thus, applications 110, 130 may use application integrator 120 to communicate with each other. It should be appreciated that in other embodiments, applications 110, 130 may reside on different platforms and/or may use different message formats than the examples provided.

As can be appreciated, a wide number of different types of applications 110, 130 may use application integrator 120. As one example, application 130 may be an account management system that processes transactions and requests related to financial accounts, such as credit and/or debit card accounts and application 110 may be an application (e.g., an Internet application) used to obtain or receive information about customer financial accounts. A customer, or bank representative, may interact with application 110 using any of the devices 102, 104, 106 previously described or other device. Financial institution application 110 may transmit/receive XML messages, while account management system application 130 may transmit/receive COBOL messages. Application integrator 120 may be used to allow the applications 110, 130 to communicate with each other.

A variety of different types of messages may be transmitted between the financial institution application 110 and the account management system application 130. In some instances, the messages may be two-way messages that require a response from the other application, while in other instances, the messages may be one-way messages that do not require a response. Exemplary two-way messages that may be sent from the financial institution application to the account management application include account balance inquires, transaction history inquiries, or any other type of message requesting information about financial accounts. An exemplary two-way message that may be sent from the account management system to the financial institution application is an authorization notification message for an authorization made on a credit or debit card account, which requires the financial institution application to acknowledge the message and send a receipt. One-way messages may also be transmitted by either financial institution application and/or account management system application. For example, financial institution application may transmit an address change or other account change message. As another example, account management system may transmit a message indicating a credit application is accepted. Many other types of messages may also or alternatively be transmitted between an account management system application and a financial institution application. Other types of applications that use an application integrator may transmit entirely different types of messages.

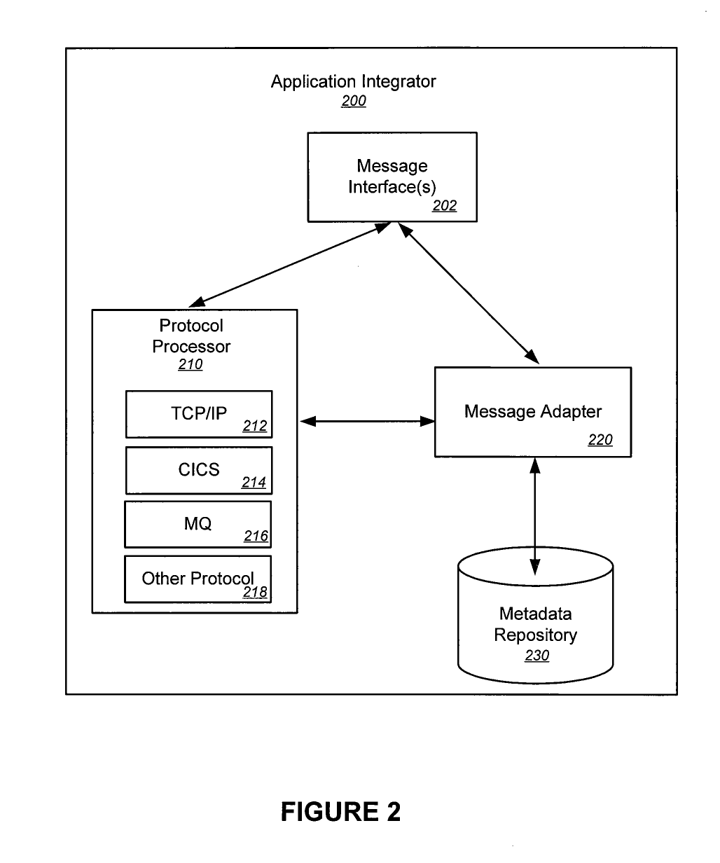

FIG. 2 illustrates an exemplary embodiment of an application integrator 200. Application integrator 200 may include one or more message interface(s) 202, protocol processor 210, message adapter 220, and metadata repository 230.

Message interface(s) 202 may be used to transmit and receive messages from applications. Merely by way of example message interfaces(s) may comprise an interface to a public network (e.g., the Internet), an interface to a proprietary network, a bus, a wireless interface, or any other type of interface that may be used to transmit/receive messages. Some message interface(s) may share the same physical interface to a machine (e.g., an Ethernet interface), while other message interface(s) may use a different interface (e.g., a Token Ring or Fiber Channel interface).

In some embodiments, application integrator 200 may be able to receive messages that use different communication protocols for the transportation layer. By way of example, application integrator 200 may receive messages that use TCP/IP, CICS, MQ, and/or other types of transport protocols. Hence, in these embodiments, application integrator may include a protocol processor 210 to unwrap incoming messages from its transport protocol and wrap outgoing messages into the appropriate transport protocol. The protocol processor 210 may include different components, such as TCP/IP 212, CICS 214, MQ 216, and/or other protocols 218 to process each protocol supported by application integrator 200.

Message adapter 220 may be communicatively coupled with protocol processor 210 and metadata repository 230. Message adapter 220 may also be communicatively coupled with message interface(s) to transmit messages via an internal message interface (e.g., bus). As will be described in more detail below, message adapter 220 may use metadata included in metadata repository 230 to adapt a message to a different format. Merely by way of example, message adapter may adapt a COBOL message to an XML message or visa versa.

Protocol processor 210 and message adapter 220 may be implemented in software and/or hardware logic. Hence, protocol processor 210 and message adapter 220 may be one or more software programs, one or more components of a software program (e.g., function or program object), firmware, or other type of machine-executable instructions.

Metadata repository 230 may contain information used by message adapter 220 to adapt a message to a different format. The metadata repository 230 may be one or more Virtual Storage Access Method (VSAM) files, internal software list(s), relational databases, object databases, or any other suitable data structure. In one specific embodiment, the basic meta-data for XML tags and COBOL fields is stored in easily read format using Index sequential files, referred to as VSAM files. Also, XML to COBOL and COBOL to XML transformations are held in a highly-optimized, pre-compiled, format which removes the need for length access to the base meta-data. Further, all meta data may be cached in memory to ensure that no I/O takes place when the meta data is referenced. Changes to meta-data are immediately replicated on the disk before being re-cached. The metadata included in metadata repository 230 may comprise mappings between data elements in one message format to data elements in another message format. For instances, a message definition may be provided which maps input and/or output data elements in one message format (e.g., XML tag) to corresponding input and/or output data elements in another message format (e.g., COBOL data field). The message definition may also map the message type to one or more services used by the message type. By way of example, the message definition may include a mapping which maps an XML message type to a COBOL service used by the XML message.

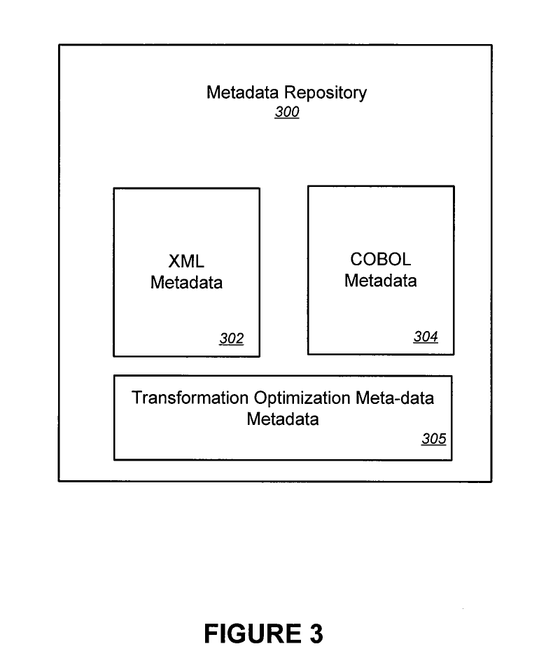

In some embodiments, metadata may also include data structure metadata (e.g., data type, field length, data position) for data elements associated with one or more of the message formats. For instances, the metadata may include field names, lengths, formats and other information for COBOL data elements. Other types of metadata may also be stored in metadata repository 230. Further exemplary details about a metadata repository 230 will be described below, with reference to FIG. 3.

It should be appreciated that application integrator 200 may include additional, alternative, or fewer components than illustrated in FIG. 2. For example, application integrator 200 may not receive/transmit messages using different transportation layer protocols and thus protocol processor 210 may not be included. As another example, logic may be provided to process message headers; perform message monitoring, logging and/or reporting; generate metadata; and/or other functionality used to facilitate communication between applications using different message formats. Other variations are also contemplated.

FIG. 3 illustrates an exemplary embodiment of a metadata repository 300, which may be used by an application integrator to adapt messages to a different format. In the exemplary embodiment, application integrator is used to convert XML messages to COBOL messages and visa versa. As should be appreciated, variations may be made to the metadata repository 300 to adapt messages that use formats other than XML or COBOL.

Metadata repository 300 may include XML metadata 302 that may contain message definitions for data elements used in incoming or outgoing XML messages. An XML message definition may include the XML message type, a COBOL service used by the XML message type, the version of the COBOL service, the name of a default header associated with the XML message (which may be used to transmit a response), an input layout which maps input data elements associated with XML tags in a request message to their corresponding COBOL data element field, and output layout which maps output XML tags to be included in a response message to a COBOL data field, and/or any other data describing an XML message used to convert the XML message to COBOL.

Metadata repository 300 may also include COBOL metadata which contains data structure and/or other information on COBOL data elements. The data structure information may include information such as data element name, data element type (format), data length, location information (such as data position), or any other information about COBOL data elements. In some aspects, application integrator may be used to generate the COBOL metadata.

As shown in block 305, metadata repository 300 further includes transformation optimization meta-data metadata. The first time that a message is transformed from COBOL to XML or XML to COBOL, a detailed transformation instruction set is constructed from the basic meta-data. This instruction set is in itself meta-data which is then stored inside the meta-data repository at block 305 to speed-up all future executions of the same transformation. In other words, the transformation instructions set may comprise optimization algorithms and meta-data storage designed to perform transformations at a very high speed with minimal impact to overall message performance.

Merely for illustrative purposes, an example XML message definition for a balance inquiry message and corresponding COBOL metadata will now be described. The XML message definition may include metadata that describes the XML message type of BALANCE.INQUIRY uses COBOL service APPLICATION.BALINQ. The XML message definition may also include metadata which describes that the output response message should include an XML tag=CurrBal, which corresponds to CURR-BAL field on ABC record. COBOL metadata may then describe information about the COBOL field. For example, the COBOL metadata may include metadata which describes that the filed CURR-BAL is in position 1234 of ABC record, has a length of 9 bytes, and is a packed decimal type. The XML message definition may also include other information, such as an input layout which describes mappings between input data elements (e.g., account number, financial institution identifier) and the corresponding COBOL data element fields, which may be described further in COBOL metadata. It should be appreciated that many variations may be made to the illustrative example.

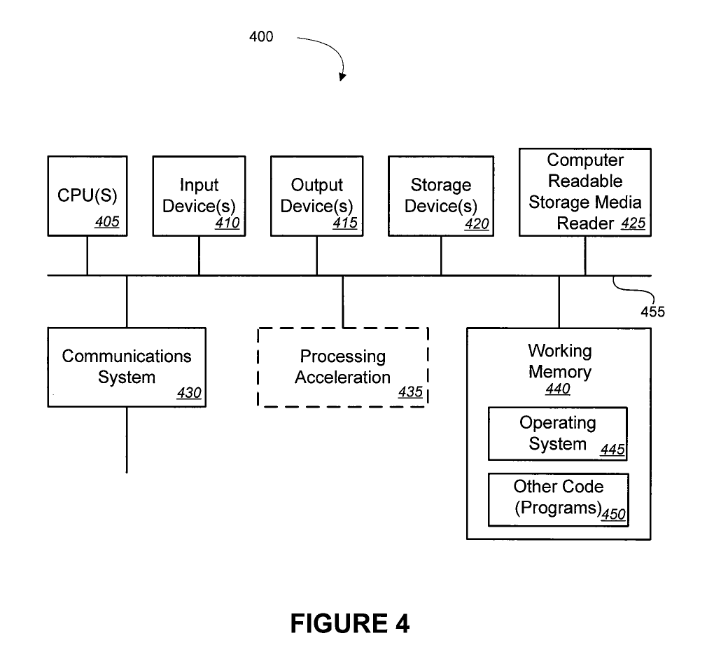

FIG. 4 illustrates one embodiment of a computer system 40 upon which an application integrator may be implemented. The computer system 400 is shown comprising hardware elements that may be electrically coupled via a bus 455. The hardware elements may include one or more central processing units (CPUs) 405; one or more input devices 410 (e.g., a scan device, a mouse, a keyboard, etc.); and one or more output devices 415 (e.g., a display device, a printer, etc.). The computer system 400 may also include one or more storage device 420. By way of example, storage device(s) 420 may be disk drives, optical storage devices, solid-state storage device such as a random access memory (“RAM”) and/or a read-only memory (“ROM”), which can be programmable, flash-updateable and/or the like.

The computer system 400 may additionally include a computer-readable storage media reader 425; a communications system 430 (e.g., a modem, a network card (wireless or wired), an infra-red communication device, etc.); and working memory 440, which may include RAM and ROM devices as described above. In some embodiments, the computer system 400 may also include a processing acceleration unit 435.

The computer-readable storage media reader 425 can further be connected to a computer-readable storage medium, together (and, optionally, in combination with storage device(s) 420) comprehensively representing remote, local, fixed, and/or removable storage devices plus storage media for temporarily and/or more permanently containing computer-readable information. The communications system 430 may permit data to be exchanged with a network and/or any other computer or other type of device.

The computer system 400 may also comprise software elements, shown as being currently located within a working memory 440, including an operating system 445 and/or other code 450, such as application program(s). The application program(s) may implement an application integrator, components of an application integrator, and/or the methods of the invention. It should be appreciated that alternate embodiments of a computer system 400 may have numerous variations from that described above. For example, customized hardware might also be used and/or particular elements might be implemented in hardware, software (including portable software, such as applets), or both. Further, connection to other computing devices such as network input/output devices may be employed.

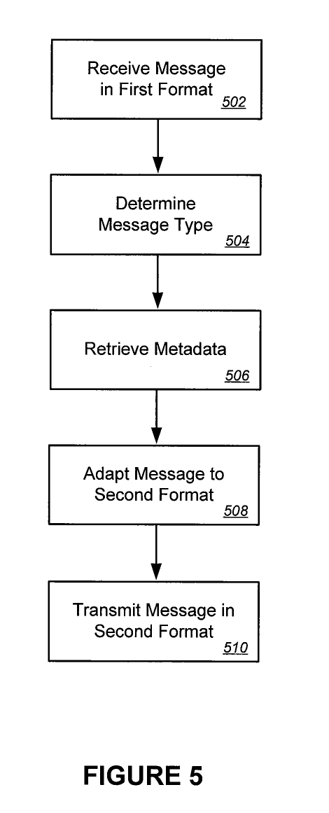

FIG. 5 illustrates an exemplary embodiment of a method that may be used by an application integrator to adapt a message from a first format to a second format. The method may begin by receiving 502 a message from an application. The message is received 502 in a first format, such as XML or COBOL. The message may be a two-way message that requires a response from the recipient application or a one-way message that does not require a response. Merely by way of example, the message may comprise an account inquiry, account balance request, transaction history request, or other type financial account information request. As another example, the message may comprise an authorization message to notify a financial institution of a credit or debit authorization made on an account. Other types of messages may also be received 502.

At block 504, a message type for the received message is determined 504. The message type may be identified in the message (e.g., in a header section of the message). Thus, the message type may be determined 504 by parsing the message. Other techniques may also be used to determine the message type.

Once the message type is determined 504, metadata associated with the message type may be retrieved 506. The metadata may include one or more mappings which associate data elements used by the first message format to data elements used by the second message format. By way of example, the metadata may map input data element(s) associated with the message type (e.g., XML tag(s)) to corresponding data element(s) used by the second message format (e.g., COBOL data field(s)). In some embodiments, the mappings may be stored as part of a message definition. The message definition may include additional information about a message, such as the name of the service in the second application used by the message. For message types that are two-way messages, an output layout which maps output data elements to corresponding elements in the second format, may also optionally be included in the metadata (e.g., as part of the message definition).

Additional metadata may also be retrieved 506 that further describes the corresponding data elements in the second format. For example, metadata may be retrieved that describes the data structure of the corresponding data elements, such as the data type, length, location information (e.g., record identifier and/or position), or other additional information about the corresponding data element. The additional metadata may facilitate the conversion of data values associated with input data elements to the second message format.

At block 508, the metadata is used to adapt the received message to the second format used by a second application. For example, an XML message may be adapted to a COBOL message, or visa versa. The adapted message in the second format may then be transmitted 510 to the second application for processing.

As previously described, in some aspects, the message may be a two-way message in which a response from the second application is expected or required. In these aspects, the application integrator may be used to adapt the response message from the second format used by the second application to the first format used by the first application. In some instances, the retrieved metadata 506 may also include an output layout. The output layout may include associations between output data elements used in the first message format to output data elements used in the second message format. For example, the output layout may include output XML tags which are mapped to data elements received in a response message. The metadata may thus be used to adapt a response message received from the second application to the first format. Additional metadata, such as metadata which describes the data structure of output data elements used by messages in the second format, may also be retrieved and used to adapt the message (e.g., to obtain data values associated with the output data elements). The adapted response message may then be transmitted to the first application.

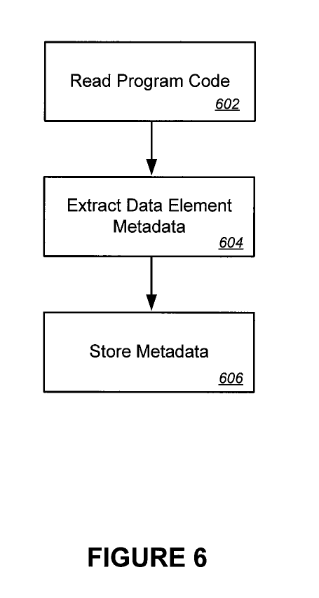

In some embodiments, application integrator, or other system, may generate some of the metadata used to adapt messages to a different format. FIG. 6 illustrates an exemplary method that may be used to generate metadata.

At block 602, program code used by an application (e.g., a COBOL copybook) may be read 602. The program code may then be parsed to extract 604 information about data elements used by the program code. For example, the information for a data element may include a data element name, data type, length of field, number of occurrences, data position or other location information, or other information about the data element's data structure.

The extracted information about the data elements may be stored 606 in a metadata repository. The information may then be used to facilitate the adaptation of messages to/from the format used by the second application.

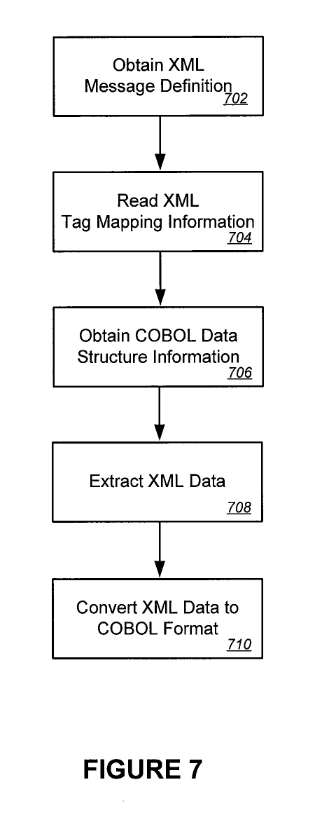

FIG. 7 illustrates an exemplary method that may be used by an application integrator to adapt an XML message to a COBOL message. An XML message definition associated with the type of XML message received may be obtained 702 from a metadata repository. The XML message definition information may include mappings which map XML tags that may be included in XML messages of the associated type to COBOL data elements. The XML tag mapping information may be read 704 from the message definition.

Data structure information for the COBOL data elements corresponding to the XML tags may also be obtained 706 from the metadata repository. Merely by way of example, the data structure information for a COBOL data element may include the data type, field length, data position, or other information about the COBOL data element. This information may be used to convert data values to the appropriate COBOL format.

The data values associated with the XML tags are extracted 708 and converted 710 to the COBOL format used by the second application. The XML tag mapping information, COBOL data structure information, and/or other metadata are used during the extraction and conversion process. A COBOL message may then be transmitted to the second application which invokes the associated service with the appropriate COBOL data elements. As previously mentioned, the first time that a message is transformed from COBOL to XML or XML to COBOL, a detailed transformation instruction set is constructed from the basic meta-data. This instruction set is in itself meta-data which is then stored inside the meta-data repository to speed-up all future executions of the same transformation.

As one example, the method described above may be used to convert an account balance inquiry message to a COBOL message. In this example, the XML message definition information may include the COBOL service name used by the second application (e.g., account management system application) to process account balance inquiries. The message definition information may also include an input layout which maps input XML tags that may be included in the account balance inquiry message (e.g., account number, financial institution identifier) to their corresponding COBOL data elements. The COBOL data structure metadata may further describe the data structure of the corresponding COBOL data elements. The XML message definition and COBOL data structure information may be used to construct a COBOL account inquiry message and to convert the data values included in the XML account balance inquiry to COBOL. The COBOL account inquiry message may then be sent to the second application for processing. It should be appreciated that other types of messages may also be adapted using the process described in FIG. 7.

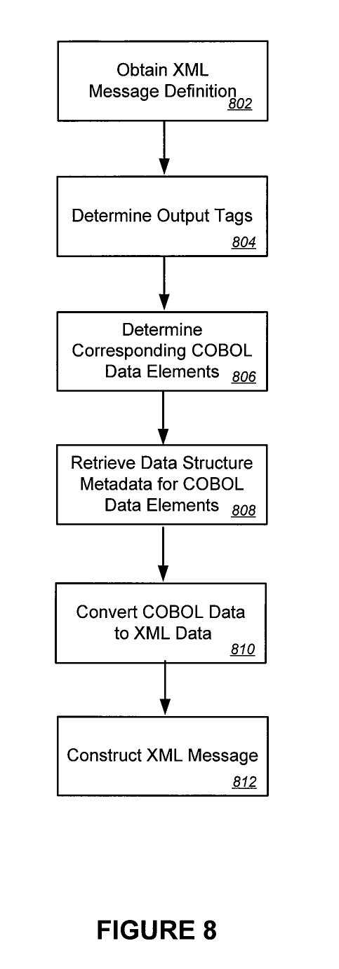

FIG. 8 illustrates an exemplary embodiment of a method that may be used by an application integrator to adapt a COBOL message to an XML message. The XML message definition 802 to construct the XML message may be obtained at block 802.

At block 804, the output tags for the XML message are determined. The output tags may be described in an output layout included in the message definition. The output layout may also include mappings which associate the output tags to their corresponding COBOL data elements. These mappings are used to determine 806 the COBOL data elements corresponding to the XML output tags to be included in the XML message.

Data structure metadata for the COBOL data elements corresponding to the output tags is then retrieved 808 from a metadata repository. This information may be used to locate and extract data values from the COBOL message. The COBOL data may then be converted 810 to XML data. Finally, the XML message with the appropriate header and output tags and associated data values may be constructed 812. The XML message may then be transmitted to the first application. This may involve a transformation instruction set which is constructed from the basic meta-data and stored in a repository. In this way, all future execution of the same transformation may be made more efficiently.

As one example, the COBOL message to be converted may be a response to the account balance inquiry message example described with reference to FIG. 7. In this example, the XML message definition may include an output layout which maps the output XML tag “CurrBal” expected by the first application to the COBOL data element “CURR-BAL” field on ABC record. The COBOL data structure metadata may include information that the field CURR-BAL is located in position 1234 of ABC record, has a length of 9 bytes, and is a packed decimal. This information may be used to extract the data value associated with the current balance from the COBOL message and the data value may be converted to a displayable format. An XML message, with the appropriate header, may then be constructed which includes the output tag “CurrBal” and the converted data value.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving, at an application integrator, a message in a first format from a first application;
determining, with the application integrator, a message type for the message;
retrieving, with the application integrator, metadata associated with the message type, the metadata including at least one mapping associating a data element in the first format to a data element in a second format;
using the metadata to adapt the message in the first format to a second message in the second format; and
transmitting the second message to a second application.

2. The method of claim 1, wherein the message includes an input data element and wherein using the metadata comprises determining a corresponding data element in the second format for the input data element.

3. The method of claim 2, further comprising:
retrieving, with the application integrator, second metadata, the second metadata including data structure information for the corresponding data element; and
using the second metadata to adapt the message to the second format.

4. The method of claim 3, wherein using the second metadata to adapt the message comprises using the data structure information to convert a data value associated with the input data element from the first format to the second format.

5. The method of claim 3, further comprising generating the second metadata.

6. The method of claim 5, wherein generating the second metadata comprises parsing program code to obtain the data structure information.

7. The method of claim 6, wherein parsing the program code comprises parsing a Common Business Oriented Language (COBOL) copybook.

8. The method of claim 3, wherein the data structure information for the corresponding data element includes one or more of a data type, a field length, and a data position.

9. The method of claim 1, further comprising:
receiving, at the application integrator, a response message from the second application, the response message in the second format;
retrieving the metadata;
using the metadata to adapt the response message to a second response message in the first format; and
transmitting the second response message to the first application.

10. The method of claim 9, wherein the response message includes an output data element, and wherein adapting the response message comprises:
retrieving, with the application integrator, second metadata including data structure information for the output data element; and
using the second metadata to obtain a data value associated with the output data element from the response message.

11. The method of claim 1, wherein the message comprises one of a financial account information request and a financial account authorization message.

12. The method of claim 1, wherein one of the first format and the second format is Common Business Oriented Language (COBOL).

13. The method of claim 12, wherein the other format is Extended Markup Language (XML).

14. A method comprising:
parsing, with an application integrator, program code to obtain metadata for data elements included in the program code, the metadata including data structure information for the data elements;
storing the metadata; and
using the metadata to convert a message from a first format associated with the program code to a second format.

15. The method of claim 14, wherein the data structure information for one of the data elements includes one or more of a data type, a field length, and a data position.

16. The method of claim 14, wherein parsing the program code comprises parsing a Common Business Oriented Language (COBOL) copybook.

17. An application integration system comprising:
at least one message interface to receive a message in a first format from a first application;
a data store including a plurality of message definitions for message types in the first format, each message definition including one or more mappings associating a data element in the first format to a data element in a second format;
logic, communicatively coupled with the first communications interface and the metadata, to determine a message type associated with the message, to retrieve the message definition associated with the message type, and to adapt the message to a second message in the second format based at least in part on the retrieved message definition; and
wherein the at least one message interface is further configured to transmit the second message to a second application.

18. The application integration system of claim 17, further comprising:
second metadata including data structure information for one or more data elements included in a function associated with the second application; and
wherein the logic is configured to use the second metadata to adapt the message.

19. The application integration system of claim 18, wherein the logic is further configured to generate the second metadata by at least parsing the source code associated with the function.

20. At least one machine-readable medium, having stored thereon sequences of instructions, which, when executed by the machine, cause the machine to perform the actions of:
receiving a message in a first format from a first application;
determining a message type for the message;
retrieving metadata associated with the message type, the metadata including at least one mapping associating a data element in the first format to a data element in a second format;
using the metadata to adapt the message in the first format to a second message in a second format; and
transmitting the second message to a second application.

21. The machine-readable medium of claim 20, further comprising instructions, which, when executed by the machine, cause the machine to perform the further actions of:
generating second metadata, the second metadata including data structure information for one or more data elements associated with the second format; and
wherein the instructions for adapting the message further comprise instructions, which, when executed by the machine, cause the machine to perform the actions of using the second metadata to adapt the message to the second format.
